(19) United States
(12) Patent Application Publication
(10) Pub. No.: US 2009/0102150 A1
(43) Pub. Date: Apr. 23, 2009

(54) Duck hunting cart

(76) Inventor: Jared Thomas Dumlao, Lodi, CA (US)

Correspondence Address: Jared T. Dumlao, 825 West Locust Street, Lodi, CA, 95240, US

(21) Appl. No.: 12/283,851

(22) Filed: Sep. 15, 2008

Related U.S. Application Data
(60) Provisional application No. 60/973,068, filed on Sep. 17, 2007.

(51) Int. Cl. B62B 1/00

(52) U.S. Cl. 280/47.331

(57) ABSTRACT

The objective of the invention is to allow a hunter to balance out the weight of his decoys' and all other hunting gear that is necessary without carrying anything on his/her person. When the hunt sight is reached, all his gear pulls out of the cart in a tub capable of floating at least (300) three hundred pounds. All this minimizes energy expelled by the hunter needed throughout his/hers day. Any Duck Hunter would appreciate this cart.

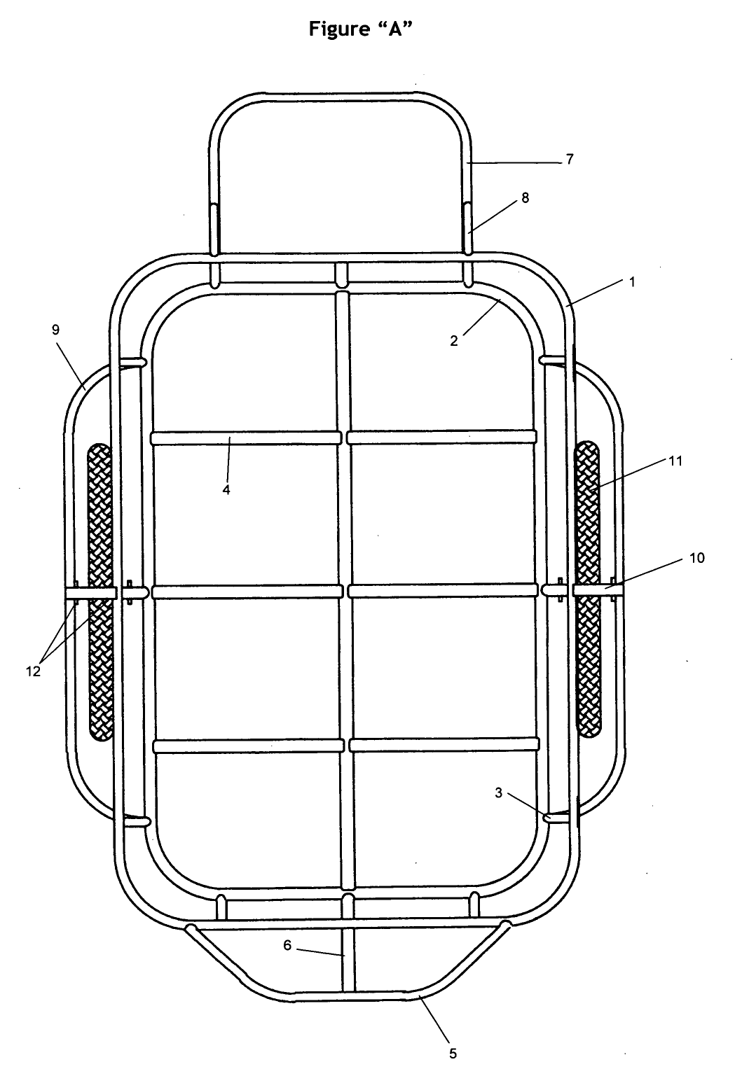

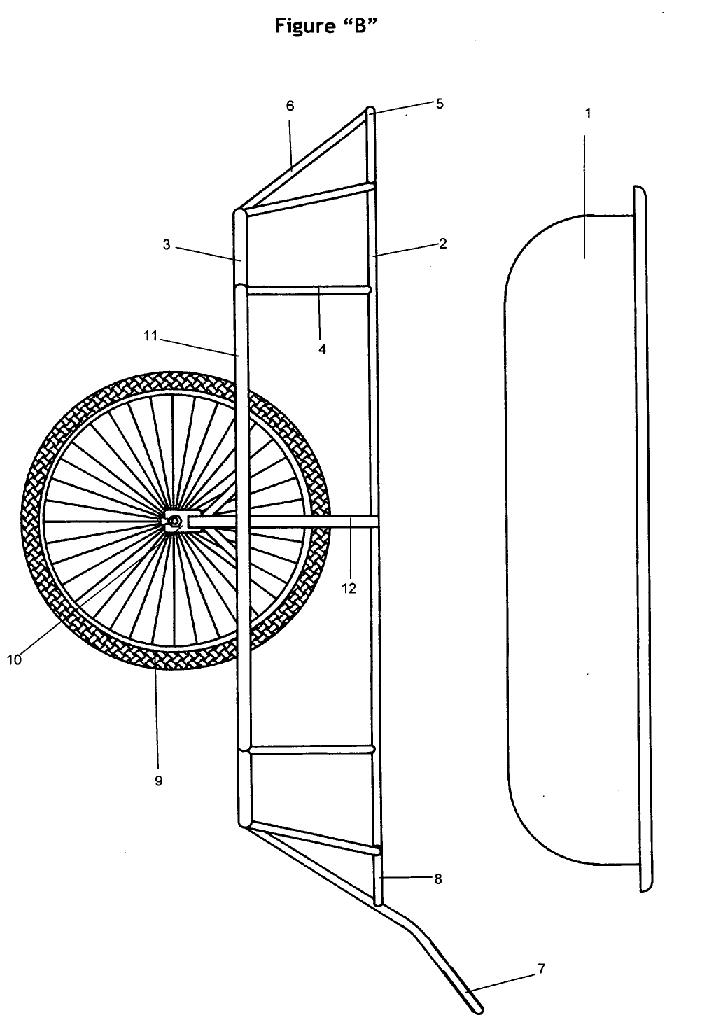

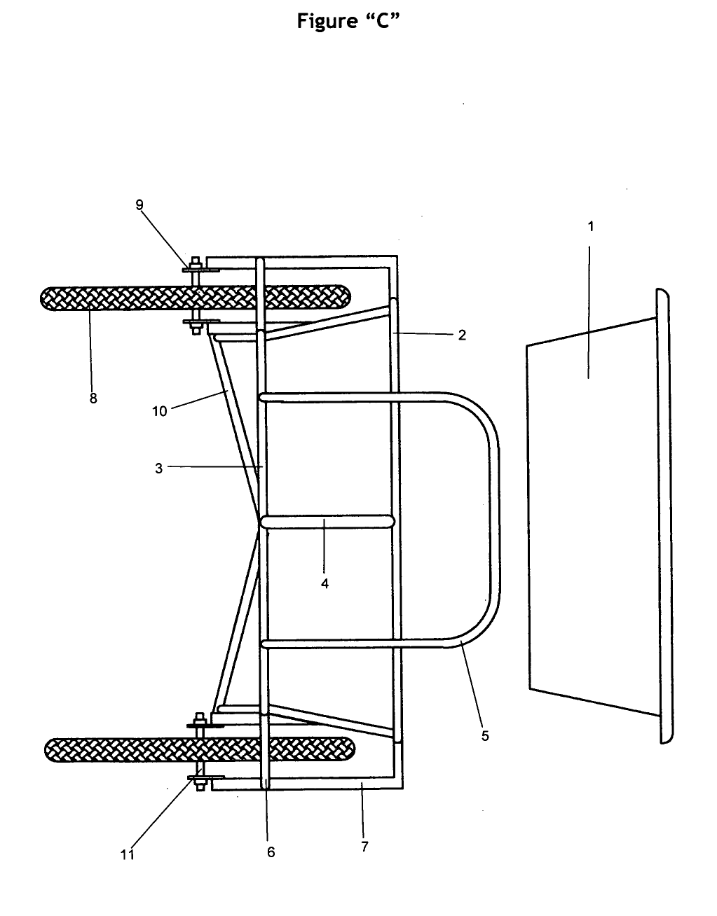

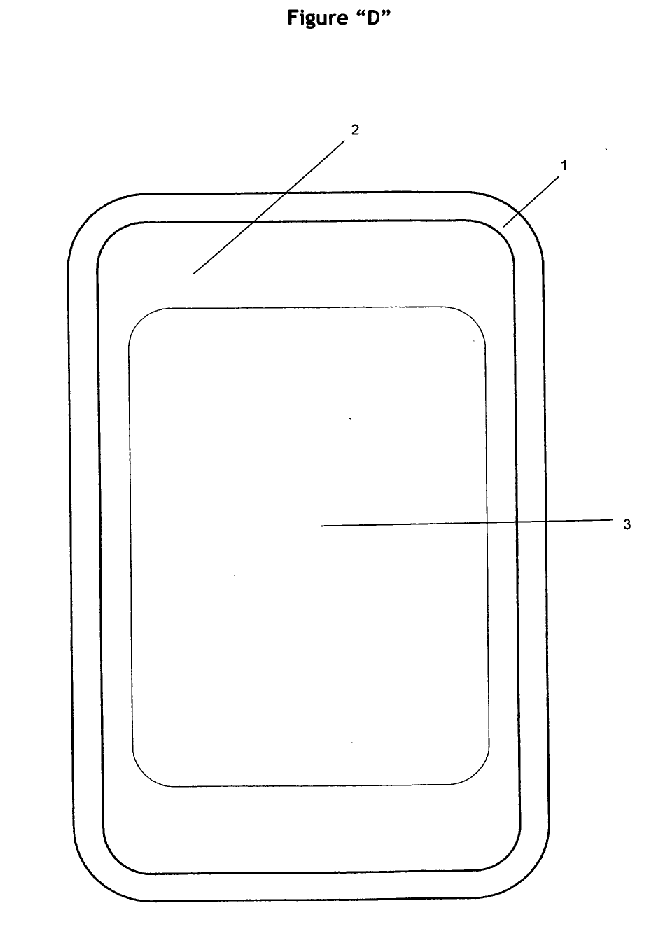

The present invention relates to a lightweight and strong cart that allows a hunter to balance out the weight of his decoys' and all other hunting gear that is necessary without carrying anything on his/her person.

The cart is comprised of the following components:
The frame of the cart is made of galvanized tubing, and is built for strength to hold heavy loads but yet is balanced and agile.
A thick plastic tapered tub sits within the tapered frame of the cart. Once cart is tipped forward, tub can be easily pulled out of frame with load in it, and slid into water and floated behind person.

The frame holds the tub securely, and can hold the weight loaded into the tub. Tub is tapered and cart frame is built tapered to tub for easy removal under heavy loads. Once hunter easily pushes his cart to hunting site the hunter can slide tub from frame and float it behind him to his duck blind. May come with gun holders, detachable cover, quick release wheel axles, (2) two styles of frame to choose from.

It can be used for various game hunting, gardening, abalone fishing, and camping. It may be attached to a bicycle, motorcycle or quad runner for various hauling.

### FIGURE “A”

1) Top Frame
2) Bottom Frame
3) Gusset
4) Crossbars lower frame
5) Front Bumper
6) Front Bumper Support
7) Handle
8) Handle Support
9) Fender
10) Fender Support
11) Wheel
12) Wheel Fork

### FIGURE “B”

1) Tub
2) Top Frame
3) Bottom Frame
4) Gusset
5) Front Bumper
6) Front Bumper Support
7) Handle
8) Handle Support
9) Wheel
10) Wheel Fork
11) Fender
12) Fender Support

### FIGURE “C”

1) Tub
2) Top Frame
3) Bottom Frame
4) Gusset
5) Handle
6) Fender
7) Fender Support
8) Wheel
9) Wheel Fork
10) Wheel Fork Support
11) Wheel Axle

### FIGURE “D”

1) Top lip of Tub
2) Inner Tapered Edge of Tub
3) Inner Bottom of Tub

What is claimed is:

1. A lightweight and strong cart that allows a hunter to balance out the weight of his decoys' and all other hunting gear that is necessary without carrying anything on his/her person. Frame of the cart is very strong and withstands the elements that in tells Duck Hunting. Also, very lightweight, equipped with a thick plastic tub that sits snuggly within the frame of the cart holding up to (300) three hundred pounds. Tub pulls out of the frame with ease and floats behind the hunter.
